(19) United States
(12) Patent Application Publication
(10) Pub. No.: US 2025/0344007 A1
(43) Pub. Date: Nov. 6, 2025

(54) ANGLED SURROUND ATTACHMENT

(71) Applicant: Rockford Corporation, Tempe, AZ (US)

(72) Inventor: Jason Thomas, Tempe, AZ (US)

(73) Assignee: Rockford Corporation, Tempe, AZ (US)

(21) Appl. No.: 19/197,377

(22) Filed: May 2, 2025

Related U.S. Application Data
(60) Provisional application No. 63/641,663, filed on May 2, 2024.

(51) Int. Cl. H04R 1/02

(52) U.S. Cl. CPC H04R 1/026

(57) ABSTRACT

Systems, methods, and devices are provided for an audio device comprising: An audio device, comprising a frame, a diaphragm, and a surround comprising a first end and a second end, wherein the first end is coupled to the diaphragm, and wherein the second end comprises a first interface coupled to the frame, the first interface comprising an angled surface having an angle in the range of about 10° to about 80° relative to an axis of the audio device.

### FIELD OF INVENTION

The present disclosure relates generally to improvements in speaker configurations, and, in particular, to improved surround attachments.

### BACKGROUND

In the area of audio speaker design, it is typical to attach the surround of the speaker to a frame. The frame/surround attachment interface has typically been a horizontal interface (relative to the axis of the speaker). In other instances, the frame/surround attachment interface has been vertical (e.g. parallel to the axis of the speaker). While these interface locations are effective, they may require the speaker dimensions to be larger than desired. For instance, with a horizontal interface, the frame may have to be wider to accommodate the attachment point, while with a vertical interface, the frame must stretch vertically to accommodate the attachment point, resulting in a higher profile and bulkier speaker. Consequently, an improvement is desired to ensure secure attachment of the surround to the frame without impacting speaker dimensions.

### SUMMARY

In an example embodiment, an audio device is disclosed, comprising: a frame, a diaphragm, and a surround comprising a first end and a second end, wherein the first end is coupled to the diaphragm, and wherein the second end comprises a first interface coupled to the frame, the first interface comprising an angled surface having an angle in the range of about 10° to about 80° relative to an axis of the audio device. In various embodiments, the angled surface has an angle of about 45° relative to the axis. In various embodiments, the angled surface faces towards the axis. In various embodiments, the angled surface faces away from the axis.

In various embodiments, the second end of the surround further comprises a second interface positioned opposite the first interface, wherein the angled surface of the first interface faces towards the axis and the second interface comprises an angled surface facing away from the axis. In various embodiments, the second end of the surround further comprises a second interface positioned opposite the first interface, wherein the second interface is a vertical surface parallel with respect to the axis. In various embodiments, the second interface contacts the frame.

In various embodiments, the first interface couples the surround to the frame through adhesive. In various embodiments, the audio device further comprises a groove disposed within the frame and configured to capture excessive adhesive, wherein the groove is positioned adjacent to the second end of the surround. In various embodiments, the frame comprises a receiving surface for receiving the interface, wherein the receiving surface is angled to match the angle of the first interface relative to the axis of the audio device.

In another example embodiment, a surround for an audio device having a diaphragm and a frame is provided. In various embodiments, the surround comprises a first end and a second end, wherein the first end is configured to couple to the diaphragm, and wherein the second end comprises a first interface configured to couple to the frame, the first interface comprising an angled surface having an angle in the range of about 10° to about 80° relative to an axis of the audio device.

In another example embodiment, a frame for an audio device having a surround having a surround interface is provided. In various embodiments, the frame comprises a receiving surface that is angled to match an angle of the interface of the surround, wherein the angle of the receiving surface is in the range of about 10° to about 80° relative to an axis of the audio device, wherein the receiving surface is configured to be coupled to the surround interface.

### BRIEF DESCRIPTION OF THE DRAWING FIGURES

Additional aspects of the present disclosure will become evident upon reviewing the non-limiting embodiments described in the specification and the claims taken in conjunction with the accompanying figures, wherein like numerals designate like elements, and:

FIG. 1A is a perspective section view of a speaker according to various embodiments of this disclosure.

FIG. 1B is a side section view of a speaker according to various embodiments of this disclosure.

FIG. 2A is a magnified view of the delineated section from FIG. 1B according to various embodiments of this disclosure.

FIG. 2B is an alternative configuration of speaker components according to various embodiments of this disclosure.

FIG. 3 is a perspective view of a speaker according to various embodiments of this disclosure.

FIG. 4 is an alternative configuration of speaker components according to various embodiments of this disclosure.

FIG. 5 is a perspective view of a device for molding speaker components according to various embodiments of this disclosure.

### DETAILED DESCRIPTION

Reference will now be made to the exemplary embodiments illustrated in the drawings, and specific language will be used herein to describe the same. It will nevertheless be understood that no limitation of the scope of the disclosure is thereby intended. Alterations and further modifications of the inventive features illustrated herein, and additional applications of the principles of the disclosure as illustrated herein, which would occur to one skilled in the relevant art and having possession of this disclosure, are to be considered within the scope of the disclosure.

In accordance with an example embodiment, systems, devices and methods are provided for improved methods of attaching a speaker surround to a speaker frame. In various embodiments, the speaker may be a subwoofer or a traditional coaxial speaker, however, other audio devices are within the scope of this disclosure.

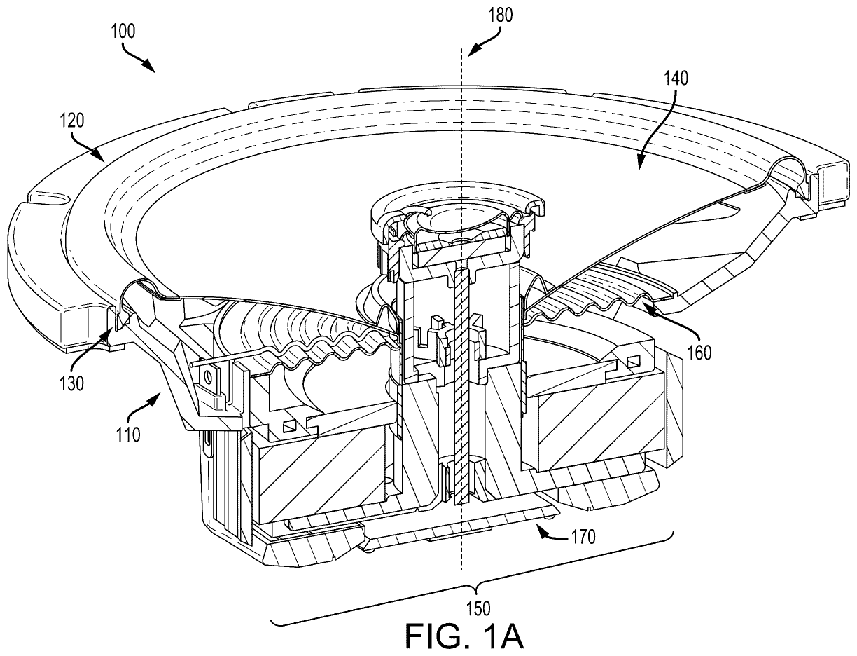

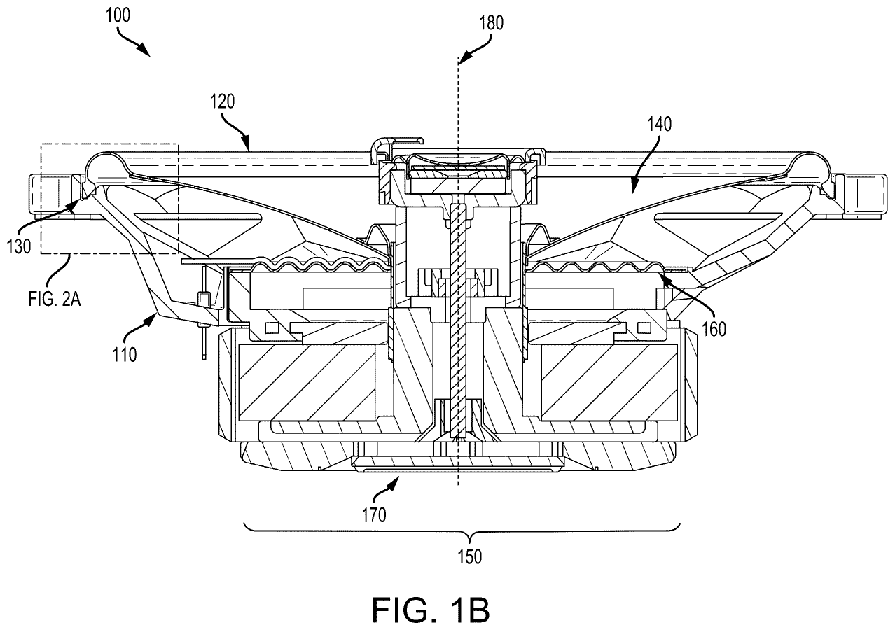

With reference now to FIGS. 1A and 1B, a speaker design as contemplated by this disclosure is shown. Speaker 100 may comprise the traditional components of most modern speakers, such as by coupling a cone-like diaphragm 140 to a frame, or basket, 110 via a suspension component called a surround 120. Frame 110 is configured to support and enclose the internal components of speaker 100, including motor structure 150 and spider 160. Speaker 100 further comprises a base 170 coupled to frame 110 and configured to support speaker 100.

Motor structure 150 may comprise a coil of fine wire, a magnet structure, and a former. When an electrical signal is applied to the coil, a magnetic field is created by the electric current in the coil. The coil and the magnet's magnetic system interact, generating a mechanical force which causes the coil and diaphragm 140 to move back and forth, producing sound. The range over which the coil and diaphragm can move is a speaker's excursion, which dictates maximum sound capabilities.

The suspension system of a speaker system maintains the coil centered in the magnetic gap and provides a restoring force to make diaphragm 140 (“cone”) return to a neutral position after moving. A typical suspension system consists of two parts, namely, spider 160 and surround 120. The spider connects diaphragm 140 and the coil to frame 110 and provides the majority of the restoring force. Surround 120 facilitates the stability of the coil and diaphragm 140 assembly as well as allows translational motion aligned with the magnetic gap. Spider 160 is usually made of corrugated fabric disk, generally with a coating of a material intended to improve mechanical properties. Surround 120 may be comprised of a roll of rubber or foam, or a ring of corrugated fabric (often coated), coupled to the outer circumference of diaphragm 140 and to frame 110. Thus, in an example embodiment, surround 120 is configured to connect the diaphragm 140 to the frame 110. In an example embodiment, surround 120 is connected to the diaphragm 140 in a sealed manner around the entire perimeter of the surround by any permanent means such as, for example, glue or co-molding. In such embodiments, the sealed nature of the speaker 100 protects internal components from contaminants, such as dust and/or liquids, preventing damage and sound distortion.

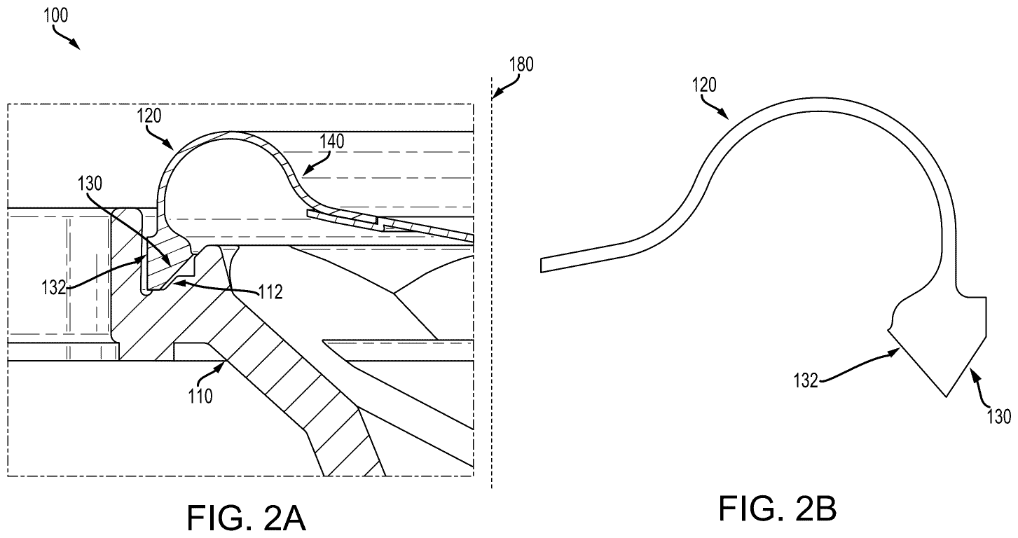

Turning now to FIG. 2A, surround 120 may couple to frame 110 at interface 130 and/or interface 132. In various embodiments, interface 130 may comprise at least one angled surface at an angle between 0 and 90 degrees relative to an axis of speaker 100, wherein the axis is illustrated by imaginary line 180. In an example embodiment, interfaces 130 and 132 are a feature of surround 120. In various embodiments, where an angle of 0 degrees with respect to line 180 lays along line 180 (i.e., parallel to the axis illustrated by imaginary line 180) and 90 degrees with respect to line 180 is perpendicular to the axis illustrated by imaginary line 180, the angle of interface 130 may be between 10 degrees and 80 degrees, preferably between 20 degrees and 70 degrees, more preferably between 30 degrees and 60 degrees, more preferably between 40 degrees and 50 degrees. In various embodiments, the angle is about 45 degrees. In various embodiments, interface 132 may be a flat surface, angled at 0 degrees from the axis (i.e. parallel to the axis illustrated by imaginary line 180).

In various embodiments, frame 110 may comprise a receiving surface 112, configured to contact interface 130, wherein receiving surface 112 is angled at the same angle as interface 130. In an example embodiment, the surround 120 is glued to the frame 110 adhering interface 130 to receiving surface 112.

In various embodiments, interface 130 may be facing outward from the axis or facing inward toward the axis. For example, in FIG. 2A, interface 130 faces inward toward the axis. In other embodiments (not shown), interface 130 may face outward from the axis. In other embodiments, interfaces 130 and 132 may both be angled with respect to the axis, such that interface 130 is a reflection of interface 132, resembling an upside-down triangle, as illustrated by FIG. 2B. In various embodiments, interface 130 may couple surround 120 and frame 110 by any means sufficient to hold the two against each other, such as, for example, glue or other adhesive.

In an example embodiment, adhesive may be applied to the angled interface 130 and not to the non-angled interface 132. For example, with reference to FIG. 2A, the surround 120 comprises a first end that is connected to the diaphragm 140, and the second end is connected to the frame 110. The second end of the surround 120 comprises the angled surface 130 that is glued to the frame. The second end may further comprise a non-angled interface 132 opposite the angled interface 130. This non-angled interface 132 may be bounded by a portion of the frame 110, creating a vertical contact. However, in an example embodiment, the surround 120 is not glued on interface 132 to the frame 110. In this regard, at least one glue groove may be provided. In various embodiments, a glue groove may be located (as illustrated) at the bottom of interface 132 for capture of residual glue (overage) in the glue groove. This glue groove may be configured to reduce excess glue being squeezed up into the vertical interface opposite the angled surface 130. In various embodiments, a glue groove may be located within frame 110 along receiving surface 112 (as illustrated). This glue groove may capture glue as it is applied to receiving surface 112 and prevent the entirety of the glue from sagging towards the bottom of interface 130, ensuring adhesive is distributed along the entirety of receiving surface 112 for an even contact with interface 130.

Interface 130 may be sufficiently sized to create a large area of attachment between surround 120 and frame 110 and ensure that they remained pressed firmly against one another so that no gap or detachment occurs. Should a gap form or surround 120 decouple from frame 110 at any point around the circumference of speaker 100, sound quality will be impacted as leakage and distortion occur. Typical speakers utilize an interface which is either horizontally (i.e. at 90 degrees with respect to the axis illustrated by line 180) or vertically (i.e. 0 degrees with respect to the axis illustrated by line 180) oriented. In such configurations, the speaker dimensions must be either widened horizontally or lengthened vertically to accommodate for the area of attachment at interface 130 required to securely couple surround 120 to frame 110. Alternatively, increasing the length of attachment of interface 130 (increasing the area of attachment) while retaining the same outer dimensions of speaker 100 would require the internal components, namely the diaphragm 140 and motor structure 150, to be smaller, minimizing the speaker's maximum excursion and ultimate sound capabilities.

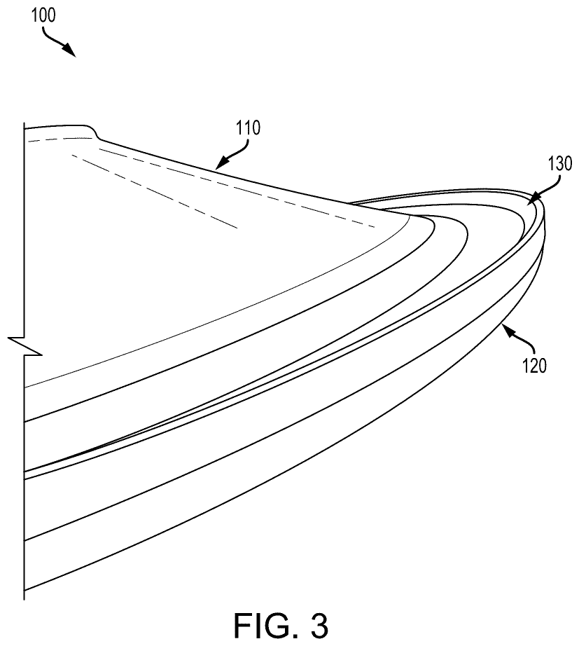

In the instant invention, the angled surface of interface 130 facilitates a larger diaphragm in speaker 100 while maintaining a low profile and compact speaker assembly. With reference now to FIG. 3, a diaphragm 140 is illustrated with a surround 120 attached to the diaphragm 140. Surround 120 may comprise an angled interface 130. In an example embodiment, the interface 130 provides a large area of attachment for surround 120 and frame 110, ensuring stability and structural integrity without requiring adjusted speaker dimensions to accommodate.

Stated another way, interface 130 is configured to reduce the speaker frame outer dimensions without reducing the diaphragm outer dimensions for a speaker with the angled interface 130 as compared to a speaker with a horizontal interface. Stated another way, interface 130 is configured to reduce the speaker height without reducing the diaphragm height or motor heigh for a speaker with the angled interface 130 as compared to a speaker with a vertical interface.

Stated yet another way, interface 130 is configured to increase the diaphragm perimeter dimension (e.g. increase the diameter of a circular speaker diaphragm) without changing the frame outer dimensions for a speaker with the angled interface 130 as compared to a speaker with a horizontal interface. Stated another way, interface 130 is configured such that the diaphragm height or motor height may be increased without increasing the speaker height for a speaker with the angled interface 130 as compared to a speaker with a vertical interface. Thus, angled interface 130 is configured to facilitate a more compact speaker without impacting the quality of the speaker, or to improve the qualities of the speaker without making the speaker larger.

Moreover, in an example embodiment, angled interface 130 is configured to have an angle relative to the axis, which angle is configured to reduce stresses at the attachment surface significantly, improving long term durability. When interface 130 is positioned horizontally (i.e. 90 degrees with respect to the axis illustrated by line 180) within speaker 100, the excursion of the speaker imparts a much larger stress force on interface 130 than when it comprises an angled surface. Thus, in an example embodiment, the angled surface is configured to distribute the forces imparted evenly across the entirety of the surface, as opposed to a flat surface wherein the imparted force is directed at just one point on the surface. This provides additional benefits to speakers having a configuration as contemplated by the current disclosure, as they will last longer and have improved stability over traditional designs.

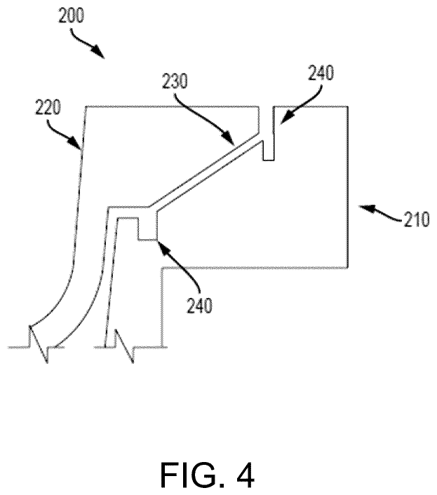

With reference now to FIG. 4, an alternative embodiment of the instant disclosure is discussed. Similar to speaker 100, speaker 200 comprises frame 210 and surround 220 coupled at interface 230. However, speaker 200 may comprise a surround that (rather than bridge above the diaphragm and frame) extends up to the frame from below the point of attachment on the frame. For example, surround 220 may be configured to extend up from below the point of attachment providing a low profile speaker. In an example embodiment, speaker 200 further comprises groove 240 configured to capture and retain any excessive adhesive. Groove 240 thereby allows for frame 210 and surround 220 to sit flush against each other without any displacement from dried adhesive, while further improving the aesthetic appearance of speaker 200 by preventing unseemly excessive adhesive residue from pooling out onto the outside surface. In various embodiments, while groove 240 may be located as shown in FIG. 4 at either or both the bottom or top of frame 210, groove 240 is not limited in this regard, and may be positioned at any point on frame 210 sufficient to capture excess glue residue, such as, for example, along a midpoint of frame 210. Further, groove 240 may be a plurality of grooves, located at multiple positions along frame 210. Stated another way, the groove 240 may be located in the frame at any suitable location(s) associated with the mating slanted portion of the frame that is adhered to the angled interface 230. In this way, groove 240 not only captures excess adhesive, but also prevents a less viscous adhesive from sliding down and pooling at the base of frame 210.

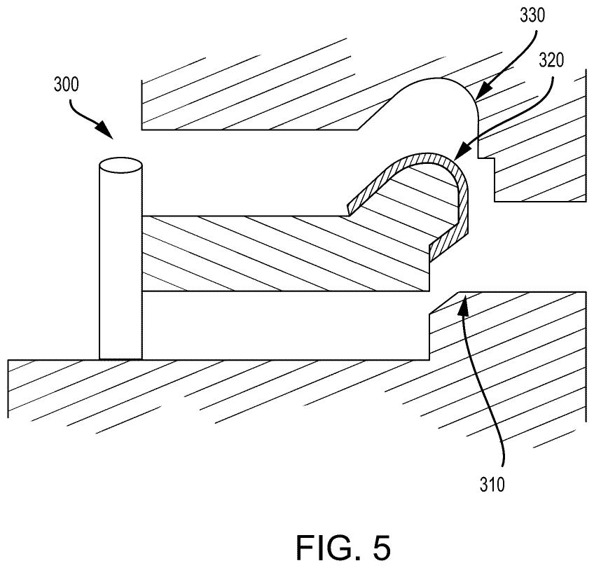

FIG. 5 illustrates a further alternative embodiment of the instant disclosure. In this embodiment, a device 300 for manufacture of the surround 320 and interface of a speaker is disclosed. The device 300 may comprise a top mold portion, a bottom mold portion and a middle mold portion. The three mold portions may be configured to mold a surround 320 having an angled interface. In this example embodiment, the top portion may comprise a receptacle 330 for creating the rounded shape of surround, pressed between the top and middle mold portions. The bottom portion may further comprise an angled portion 310 for generating the angled surface (e.g. interface 130 from FIG. 2A) of the surround. In various embodiments, any suitable method of forming the surround with angled interface may be used, such as, for example, injection molding, compression molding, and/or heat pressing.

The instant disclosure improves on traditional speakers by increasing the attachment area between a speaker's surround and frame through its angled interface in such a way that the outer dimensions of the speaker may remain the same while performance is increased. In this way, the speaker remains durable and compact, but may comprise a larger diaphragm in the same dimensions. Alternatively, the outer dimensions of the speaker may be made smaller, while performance remains constant. However, any suitable combination of improvements through use of the surround with angled interface are contemplated herein.

Example embodiments of the systems, methods, and devices described herein may be implemented in hardware, software, firmware, or some combination of hardware, software, and firmware.

In the present disclosure, the following terminology will be used: The singular forms “a,” “an,” and “the” include plural referents unless the context clearly dictates otherwise. Thus, for example, reference to an item includes reference to one or more items. The term “ones” refers to one, two, or more, and generally applies to the selection of some or all of a quantity. The term “plurality” refers to two or more of an item. The term “about” means quantities, dimensions, sizes, formulations, parameters, shapes, and other characteristics need not be exact, but may be approximated and/or larger or smaller, as desired, reflecting acceptable tolerances, conversion factors, rounding off, measurement error and the like and other factors known to those of skill in the art. The term “substantially” means that the recited characteristic, parameter, or value need not be achieved exactly, but that deviations or variations, including, for example, tolerances, measurement error, measurement accuracy limitations and other factors known to those of skill in the art, may occur in amounts that do not preclude the effect the characteristic was intended to provide. Numerical data may be expressed or presented herein in a range format. It is to be understood that such a range format is used merely for convenience and brevity and thus should be interpreted flexibly to include not only the numerical values explicitly recited as the limits of the range, but also interpreted to include all of the individual numerical values or sub-ranges encompassed within that range as if each numerical value and sub-range is explicitly recited. As an illustration, a numerical range of “about 1 to 5” should be interpreted to include not only the explicitly recited values of about 1 to about 5, but also include individual values and sub-ranges within the indicated range. Thus, included in the numerical range are individual values such as 2, 3 and 4 and sub-ranges such as 1-3, 2-4 and 3-5, etc. The same principle applies to ranges reciting only one numerical value (e.g., “greater than about 1”) and should apply regardless of the breadth of the range or the characteristics being described. A plurality of items may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. Furthermore, where the terms “and” and “or” are used in conjunction with a list of items, they are to be interpreted broadly, in that any one or more of the listed items may be used alone or in combination with other listed items. The term “alternatively” refers to selection of one of two or more alternatives, and is not intended to limit the selection to only those listed alternatives or to only one of the listed alternatives at a time, unless the context clearly indicates otherwise.

It should be appreciated that the particular implementations shown and described herein are illustrative of the example embodiments and their best mode and are not intended to otherwise limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical device.

As one skilled in the art will appreciate, the mechanism of the present disclosure may be suitably configured in any of several ways. It should be understood that the mechanism described herein with reference to the figures is but one exemplary embodiment of the disclosure and is not intended to limit the scope of the disclosure as described above.

It should be understood, however, that the detailed description and specific examples, while indicating exemplary embodiments of the present disclosure, are given for purposes of illustration only and not of limitation. Many changes and modifications within the scope of the instant disclosure may be made without departing from the spirit thereof, and the disclosure includes all such modifications. The corresponding structures, materials, acts, and equivalents of all elements in the claims below are intended to include any structure, material, or acts for performing the functions in combination with other claimed elements as specifically claimed. The scope of the disclosure should be determined by the appended claims and their legal equivalents, rather than by the examples given above. For example, the operations recited in any method claims may be executed in any order and are not limited to the order presented in the claims. Moreover, no element is essential to the practice of the disclosure unless specifically described herein as “critical” or “essential.”

What is claimed:

1. An audio device, comprising:
a frame;
a diaphragm; and
a surround comprising a first end and a second end, wherein the first end is coupled to the diaphragm, and wherein the second end comprises a first interface coupled to the frame, the first interface comprising an angled surface having an angle in the range of about 10° to about 80° relative to an axis of the audio device.

2. The audio device of claim 1, wherein the angled surface has an angle of about 45° relative to the axis.

3. The audio device of claim 1, wherein the first interface couples the surround to the frame through adhesive.

4. The audio device of claim 3, further comprising a groove disposed within the frame and configured to capture excessive adhesive, wherein the groove is positioned adjacent to the second end of the surround.

5. The audio device of claim 1, wherein the angled surface faces towards the axis.

6. The audio device of claim 1, wherein the angled surface faces away from the axis.

7. The audio device of claim 1, wherein the second end of the surround further comprises a second interface positioned opposite the first interface, wherein the angled surface of the first interface faces towards the axis and the second interface comprises an angled surface facing away from the axis.

8. The audio device of claim 1, wherein the second end of the surround further comprises a second interface positioned opposite the first interface, wherein the second interface is a vertical surface parallel with respect to the axis.

9. The audio device of claim 8, wherein the second interface contacts the frame.

10. The audio device of claim 1, wherein the frame comprises a receiving surface for receiving the first interface, wherein the receiving surface is angled to match the angle of the first interface relative to the axis of the audio device.

11. A surround for an audio device having a diaphragm and a frame, comprising:
a first end and a second end, wherein the first end is configured to couple to the diaphragm, and wherein the second end comprises a first interface configured to couple to the frame, the first interface comprising an angled surface having an angle in the range of about 10° to about 80° relative to an axis of the audio device.

12. The surround of claim 11, wherein the angled surface faces towards the axis.

13. The surround of claim 11, wherein the angled surface faces away from the axis.

14. The surround of claim 11, wherein the second end of the surround further comprises a second interface positioned opposite the first interface, wherein the angled surface of the first interface faces towards the axis and the second interface comprises an angled surface facing away from the axis.

15. The surround of claim 11, wherein the second end of the surround further comprises a second interface positioned opposite the first interface, wherein the second interface is a vertical surface parallel with respect to the axis.

16. The surround of claim 11, wherein the angled surface has an angle of about 45° relative to the axis.

17. A frame for an audio device having a surround having a surround interface, comprising:
a receiving surface that is angled to match an angle of the surround interface of the surround, wherein the angle of the receiving surface is in the range of about 10° to about 80° relative to an axis of the audio device, wherein the receiving surface is configured to be coupled to the surround interface.

18. The frame of claim 17, wherein the receiving surface is coupled to the surround interface with adhesive.

19. The frame of claim 18, further comprising a groove disposed within the frame and configured to capture excessive adhesive, wherein the groove is positioned adjacent to the surround interface.

20. The frame of claim 17, wherein the angle of the receiving surface is about 45° relative to the axis.
